(19) United States
(12) Patent Application Publication
(10) Pub. No.: US 2010/0182678 A1
(43) Pub. Date: Jul. 22, 2010

(54) Absorbing layers for the control of transmission, reflection, and absorption

(76) Inventor: William H. Southwell, Thousand Oaks, CA (US)

Correspondence Address: William H. Southwell, 1421 Feather Ave., Thousand Oaks, CA, 91360, US

(21) Appl. No.: 12/321,495

(22) Filed: Jan. 21, 2009

(51) Int. Cl. F21V 9/04; G02B 5/22

(52) U.S. Cl. 359/359; 359/360; 359/586

(57) ABSTRACT

An optical filter and a method for its design are provided that will transmit visible light and quickly cutoff to low transmission or high optical density in the near infrared wavelength region. This high optical density is achieved by either reflection or absorption of the incident light. Certain specified spectral wavelengths may be selected for absorption or reflection. These properties are achieved through the use of absorbing layers along with dielectric layers in the multilayer coating.

### STATEMENT REGARDING FEDERALLY SPONSORED RESEARCH OR DEVELOPMENT

This invention was made with Government support under subcontract USAF-5408-23-SC-0010-1-F11 awarded to Table Mountain Optics by General Dynamics Information Technology, Inc. under contract F33615-03-D-5408 awarded by U.S. Air Force. The Government has certain rights in the invention.

### CROSS-REFERENCE TO RELATED APPLICATIONS

“Not Applicable”

### REFERENCE TO SEQUENCE LISTING, A TABLE, OR A COMPUTER PROGRAM LISTING COMPACT DISC APPENDIX

“Not Applicable”

### FIELD OF THE INVENTION

This invention relates to the use of absorbing layers in the design of optical interference coatings which are used to control the transmission, reflection, and absorption of light. Specially designed coatings which include thin absorbing layers of this invention enhance the spectral control of the incident light. Coatings designed with the methods of this invention can provide absorption in specific wavelength bands in addition to the control of transmission and reflection of prior art. Furthermore, sharp transition regions are achieved with a high visible luminance transmittance and a high degree of infrared blocking in structures that are thinner than with methods of current art, making them suitable for deposition on plastics.

### BACKGROUND OF THE INVENTION

Optical interference filters are comprised of multilayer thin films usually of two materials, one with a low refractive index and one with a high refractive index. Each interface of such a structure partially reflects a portion of the incident light which in turn is partially reflected at other surfaces. These multiple reflections cause the total incident beam to be transmitted or reflected differently at different wavelengths depending on the thicknesses of the layers in the coating. Types of optical interference coatings include short wave pass edge filters, which transmit up to a cutoff wavelength beyond which they reflect. Long wave pass edge filters do just the opposite. Narrowband pass filters generally reflect light except for a narrow wavelength band which is highly transmitting.

The materials used in these multilayer coatings are dielectrics, which do not absorb light. The lack of significant absorption is necessary for the filter to work. Otherwise the light gets absorbed before it reaches the interfaces needed to produce the multiple reflections. The lack of absorption allows the coatings to be very thick which provides for greater spectral control, but at the same time makes the filter less robust. Very thick multilayer coatings tend to have internal stress making them crack, delaminate, or scatter the light through increased haze.

### Induced Transmission Filters

An Induced Transmission Filter (ITF) is one type of optical interference coatings that uses absorbing layers. ITF filters contain dielectric layers surrounding the thin metal layers which enable visible light to transmit while reflecting the longer wavelengths. Optical interference filters that reflect infrared radiation while transmitting visible light have several common usages: Low E coatings reflect long wave infrared (LWIR) to prevent heat loss from buildings while allowing visible transmission. Solar control coatings reflect the near infrared (NIR) while transmitting visible light in order to prevent solar heat from entering a building. Another use is for conducting transparent films used for displays or windows where the electrical conductivity is used to control of the optical properties or for de-icing windshields. Still another use is to provide electromagnetic shielding for windows.

All dielectric multilayer coatings known as short wave pass filters (SWP) can be used to reflect infrared (IR) and pass visible, but such filters are quite thick especially with extended band infrared reflection. Induced transmission filters (ITF) that use thin layers of silver (or other metals) with dielectric layers are able to affect the long wave IR reflection in much thinner structures than the all dielectric configuration. The use of silver (Ag) also provides conductivity for transparent coatings.

There is a tradeoff in the design of ITF filters. The more metal used the better the long wave reflection but at the expense of less luminance transmission (LT). Induced transmission filters also do not exhibit a sharp transition between the visible transmission and NIR reflection. Austin in U.S. Pat. No. 5,183,700 dated Feb. 2, 1993, teaches the combining the dielectric short wave pass configuration with the induced transmission filter to enhance the steepness of the transition. The book Thin-Film Optical Filters third edition 2001, Taylor & Francis Group, New York, pp. 215-217 by H. A. Macleod describes the basic structure for a SWP filter as (L/2 H L/2) where L and H represent layers of low and high refractive index each being one quarter wave optical thickness. The book Optical Coating Technology 2004, SPIE, Bellingham, Wash., Chapter 8 by Philip W. Baumeister teaches the basic structure of an induced transmission filter is given symbolically by DMD where D represents a dielectric layer and M represents a metal layer. Austin's configuration is then represented as (L/2 H L/2) DMD. In a later patent, U.S. Pat. No. 5,337,191 Austin shows improved transition steepness by using multiple instances of these basic units, which is represented as (L/2 H L/2) (DMDMD) (L/2 H L/2).

It would seem obvious to one skilled in the art of the design of multilayer optical coatings that further improvements may be realized by extending the configuration to include even more of the basic units. This is represented in general as (L/2 H L/2)̂R (DMD)̂S (L/2 H L/2)̂Q where R, S, and Q are integers for the number of times the basic unit is repeated. Such structures may realize even better performance when the layer thicknesses are adjusted by computer optimization. Such adjustments are called refinement which is a common practice by those skilled in the art of thin film design. It is observed, however, that designs based on these prior art configurations for filters requiring very sharp transitions between the visible transmission and near infrared blocking still suffer from insufficient NIR blocking, insufficient luminous transmission, or are too thick for some high performance applications. Very thick multilayer coatings tend to crack due to stress. This is especially an issue when the substrate is a plastic.

The objective of the prior art is to design for high visible transmission and reflect the infrared. There are applications such as for solar panels where the infrared needs to be absorbed rather than reflected. Another applications exist when it is preferred that the light not be reflected and not be transmitted.

There is a need for a thinner multilayer coating having high visible transmission and a sharp transition to block the near infrared. There is also a need for optical filters that will absorb specified spectral regions as well as for filters that will absorb specified spectral regions while also maintaining high visible transmission.

It is an object of this invention to provide a method for the design of multilayer interference coatings containing dielectric and absorbing layers that transmit visible light with high luminous transmission and are color neutral while also blocking the near infrared with a sharp transition. It is also an object of this invention to provide a method for the design of multilayer interference coatings containing absorbing layers that will absorb light in specified spectral wavelength regions and which also may or may not transmit visible light.

### BRIEF DESCRIPTION OF THE DRAWINGS

In the drawings:

FIG. 1 is a schematic representation of a multilayer coating showing the refractive index of the coating as a function of physical thickness as measured from the substrate. There are three absorbing layers which in this example embodiment have refractive index of 0.2 at a wavelength of 1000 nm.

FIG. 2 is a plot of the percent transmittance, reflectance, and absorptance as a function of wavelength for the coating shown in FIG. 1.

FIG. 3 is a plot of the log of the percent transmittance, reflectance, and absorptance. This plot shows that the optical density of the coating is three at a wavelength of about 700 nm and remains higher than three for most of the wavelengths at least out to 1350 nm.

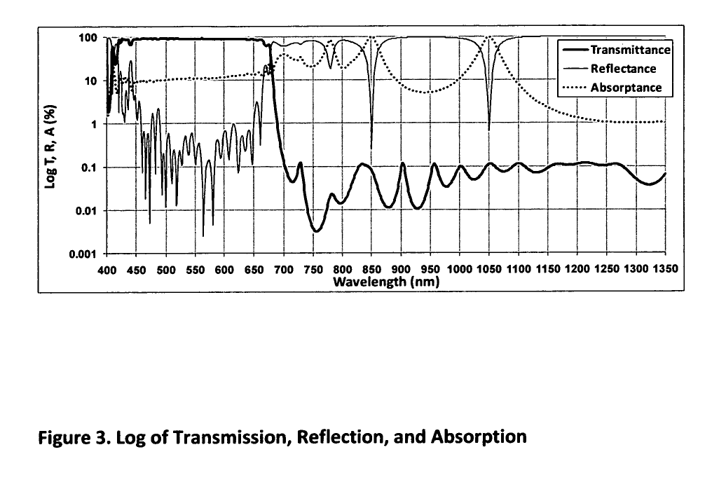

### DESCRIPTION OF THE INVENTION

The present invention is a multilayer coating consisting of layers of low and high refractive index dielectric materials along with layers of an absorbing material. The low and high index dielectric layers are generally alternating while the absorbing layers are located at various positions. The layer thicknesses are chosen such that particular spectral characteristics are met, including transmittance, reflectance, and absorptance. The number and positions of the absorbing layers are also determined so as to efficiently achieve those spectral characteristics.

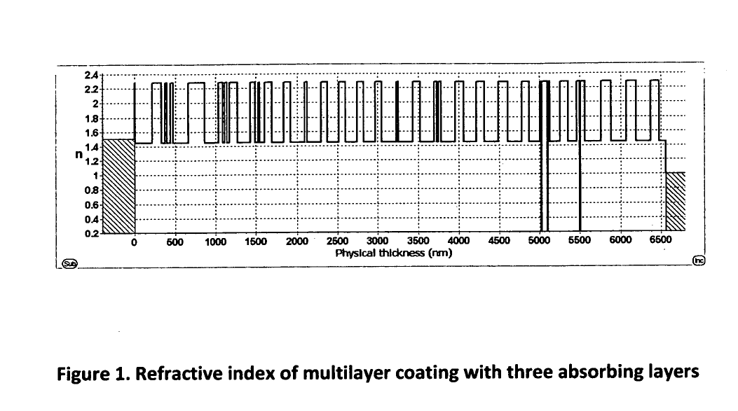

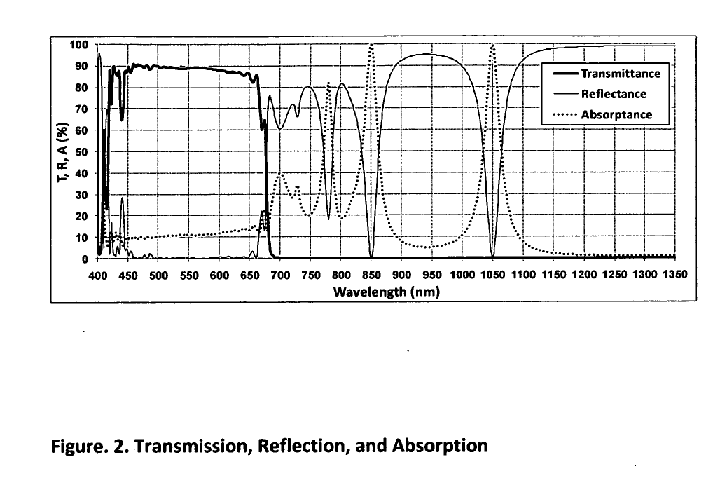

One embodiment of this invention is shown in FIG. 1. This coating consists of 68 layers and is 6557 nm physical thickness. This thickness is considerably thinner than an all dielectric coating with similar transmittance and blocking characteristics. There are three absorbing layers. The materials for this example are SiO2 and Nb2O5 for the dielectric layers and silver (Ag) for the absorbing layers. The transmittance, reflectance, and absorptance of this structure are given in FIG. 2. The spectral characteristics of this coating are that it transmits visible light with a Luminance Transmittance of 88.1%. The transmitted light is color neutral as the chromaticity coordinates are x=0.333 and y=0.341. Light is blocked in the near IR with wavelengths from 700 nm out to at least 1350 nm with an optical density of 3. Furthermore, this example embodiment coating absorbs light at two wavelengths, 850 nm and 1050 nm.

Some general features are evident for this type of coating. In the visible region the reflectance is low. This reduces the reflection loss and allows the maximum transmittance to occur. Optical coatings obey the relationship T+R+A=1 due the conservation of energy. The light is transmitted, reflected, or absorbed by the coating. When R is near zero, T and A are traded between each other. As observed in FIG. 2 in the visible region T is about 90% and A is about 10%. It is possible to adjust these percentages, for example, one could achieve 60% transmittance and 40% absorption in the visible region.

In the near infrared region, which is adjacent to the visible wavelengths, the transmittance of this class of coating designs is near zero. In this region we may trade reflection with absorption. This produces the mirror-like pattern as seen in FIG. 2 for the wavelength region from 700 nm to about 1100 nm. It is possible to achieve specified levels of reflectance and absorption in this region. This example chose to absorb light at wavelengths 850 nm and 1050 nm.

The third region of interest is the longer wave IR where Transmittance remains low and Reflectance is high. This is characteristic of previous art and is a consequence of the total thickness of the absorbing material.

The novelty of the present invention is that it provides coatings with high luminous transmission while blocking the near infrared. This is done with a very steep transition between the visible pass wavelengths and the near infrared wavelengths. This blocking region is extended to longer wavelengths in the IR. These structures are considerably thinner in overall thickness than prior art. Another novel feature is that one is able to specify whether to reflect or absorb the near IR light while still blocking it from being transmitted.

For some applications it may be important to absorb the incident light to a high degree rather than have it reflected.

While one embodiment is presented as an example it will be evident to one skilled in the art of thin film coating design that other embodiments may be achieved. The transition wavelength as well as the wavelengths chosen for being absorbed is under the control of the coating designer with the methods of this invention. The degree of blocking or optical density is also under the designer's control. Another embodiment of the present invention selects the wavelengths to be absorbed from the visible region. Yet another embodiment is to obtain high luminous transmission with low visible reflection and a sharp transition to high reflection in the near infrared and high reflection extending into the longer wavelength infrared in a structure having a relative thin total physical thickness.

It is also evident to one skilled in the art that other dielectric materials may be used. Any pair of dielectric materials having a low and a high refractive index may be used. Those in common use for optical coatings are SiO2, MgF2, SiO, Al2O3, Ta2O5, Nb2O5, ZrO2, HfO2, ZnS as well as others. It is also possible to use other metals as the absorbing material. This example has chosen Ag, but one may use other metals such as gold, chromium, or copper. It is also possible to use other absorbing materials such as the nitrides such as TaN, HfN, and ZrN.

It is also known to those skilled in coating deposition of metals that additional thin auxiliary layers around the absorbing layers may be necessary as a barrier layer or a nucleation layer. The use of such layers as well as the various methods of deposition, such as sputtering, thermal evaporation, or chemical vapor deposition are all considered within the scope of the present invention.

1. An optical filter consisting of dielectric layers of low and high refractive index but which also contains layers of an absorbing material which by means of adjusting the layer thicknesses is able to control the spectral transmission, reflection, and absorption of incident light.

2. An optical filter of claim 1 having high visible transmission and low transmission in the near infrared and infrared spectral regions.

3. An optical filter of claim 1 having high visible transmission and low visible reflection and low transmission in the near infrared and infrared spectral regions.

4. An optical filter of claim 1 having high visible transmission and high absorption in one or multiple spectral regions in the near infrared spectral regions while maintaining low transmission in the near infrared spectral regions.

5. An optical filter of claim 1 having high visible transmission and high absorption or high reflection of infrared spectral regions and exhibiting a sharp transition between the two regions.

6. An optical filter of claim 1 consisting of multiple layers of optical materials and which includes an absorbing layer or layers which may consist of metals or metal nitrites or other absorbing materials and whose layer thicknesses are determined by optimization so as to adhere to specified transmittance and reflection and absorption targets.

7. An optical filter of claim 1 wherein the dielectric layer materials are the metal oxides such as SiO2, ZrO2, Ta2O5, Nb2Ot, or TiO2.

8. An optical filter of claim 1 wherein the absorbing layer material is silver, Ag.

9. An optical filter of claim 1 wherein the absorbing layer material is a transition metal nitride, such as ZrN, TiN, or HfN.

10. An optical filter of claim 1 wherein the total thickness is thin such that coating is robust when deposited on plastics as well as on glass substrates.

11. An optical filter of claim 1 having high visible transmission and being electrically conducting.

12. An optical filter of claim 1 having high visible transmission and high absorption or high reflection infrared spectral regions while maintaining low transmission in the infrared spectral regions and being electrically conducting.

13. A method for designing an optical filter consisting of dielectric layers of low and high refractive index but which also contains layers of an absorbing material which by means of adjusting the layer thicknesses is able to control the spectral transmission, reflection, and absorption.

14. The method of claim 13 wherein the coating has high visible transmission and low transmission in the near infrared and infrared spectral regions.

15. The method of claim 13 wherein the filter has high visible transmission and low visible reflection and low transmission in the near infrared and infrared spectral regions.

16. The method of claim 13 wherein the filter has high visible transmission and high absorption in one or multiple spectral regions in the near infrared spectral regions while maintaining low transmission in the near infrared spectral regions.

17. The method of claim 13 wherein the filter has high visible transmission and high absorption or high reflection in the infrared spectral regions and exhibiting a sharp transition between the two regions.

18. The method of claim 13 consisting of multiple layers of optical materials and which includes an absorbing layer or layers which may consist of metals or metal nitrites or other absorbing materials and whose layer thicknesses are determined by optimization so as to adhere to specified transmittance and reflection and absorption targets.
